(19) United States
(12) Patent Application Publication
(10) Pub. No.: US 2018/0163890 A1
(43) Pub. Date: Jun. 14, 2018

(54) Hammering Valve

(71) Applicant: Novatek IP, LLC, Provo, UT (US)

(72) Inventors: D. Peter Johnson, Provo, UT (US); Scott Dahlgren, Alpine, UT (US)

(21) Appl. No.: 15/378,762

(22) Filed: Dec. 14, 2016

(51) Int. Cl. F16K 31/06; H01F 7/08; H01F 7/18

(52) U.S. Cl. CPC F16K 31/0679; H01F 2007/086; H01F 7/1872; H01F 7/081

(57) ABSTRACT

A valve may comprise a plug receivable by a seat wherein both the plug and seat comprise superhard material. The valve may be designed and operated in such a way so as not to fracture the superhard material as the plug is received by the seat. Specifically, the valve may comprise a magnetic core translatable within at least one solenoid. Kinetic energy from the translating magnetic core may be transmitted to the plug when the magnetic core impacts an anvil causing the plug to move relative to the seat. The plug may be moved incrementally relative to the seat by a plurality of impacts of the magnetic core.

### BACKGROUND

Poppet valves are a common type of valve typically comprising a plug capable of obstructing a hole, known as a seat. Such plugs may be translated relative to the seat to permit or restrict fluid flowing therethrough. While a variety of mechanisms have been employed to translate such plugs, it is not uncommon for a solenoid switch to fill this role. A conventional solenoid switch may comprise a metal rod disposed within an electrical conductor wound as a helix. When an electrical current is passed through the conductor a magnetic field may be established within the conductor which may translate the rod.

In various applications a plug may require additional initial force before disengaging from a seat. For instance, a plug may stick to a seat due to fluid deposits adhering thereto or high fluid pressures acting on the plug when shut. To free such a plug, U.S. Pat. No. 6,213,446 to Dismon et al. describes a magnetic coil that may be energized to produce a magnetic field, accelerating an armature to build up kinetic energy and impact against a head of a valve rod. In Dismon, when the current is turned off, the armature retracts under action of a spring. In such a manner, the armature “hammers” the valve rod to overcome sticking.

Where valves are used to control fluids comprising particularly high pressures or abrasive particles suspended therein, such fluids may damage the valves by prematurely wearing exposed surfaces. Such wear may be especially pronounced at times when the valve is just barely open due to the higher speeds that may occur through narrow orifices. In order to combat such wear, some valves have incorporated superhard materials, such as polycrystalline diamond (PCD), into their designs. For example, U.S. Pat. No. 8,640,768 to Hall et al. describes diamond coatings or films deposited on valve surfaces. Such diamond may be grown in a vapor deposition process by placing a substrate in an environment that encourages diamond grain growth and exposing the substrate to gases comprising carbon and hydrogen. Hall also describes valve components formed from PCD that may be sintered in a high-pressure and high-temperature press. During such sintering, diamond grains may be mixed with a metal catalyst that lowers the activation energy required to cause the grains to grow and bond to one another.

While such superhard materials may be helpful for erosion resistance, they are also known to be brittle. As stated by U.S. Pat. No. 9,475,176 to Bao et al., “when variables are selected to increase the hardness of the PCD material, brittleness also increases, thereby reducing the toughness of the PCD material.” Consequently, superhard materials that have been used in other types of valves have not been used in hammering poppet type valves.

### BRIEF DESCRIPTION

A hammering poppet valve may comprise a plug receivable by a seat wherein both the plug and seat comprise superhard material. The poppet valve may be designed and operated in such a way so as not to fracture the superhard material as the plug is received by the seat.

Specifically, the poppet valve may comprise a magnetic core translatable within at least one solenoid. Kinetic energy from the translating magnetic core may be transmitted to the plug when the magnetic core impacts an anvil causing the plug to move relative to the seat. The plug may be moved incrementally relative to the seat by a plurality of impacts of the magnetic core in either direction. The plug may be rigidly attached to a guide rod with two anvils affixed thereto spaced from one another along the guide rod. In one embodiment, two axially-spaced coaxial solenoids, formed from a single wire oppositely wound for each solenoid, may accurately and forcefully translate the magnetic core.

### DRAWINGS

FIG. 1 is a perspective view of an embodiment of poppet valve.

FIG. 2 is a longitude sectional view of the embodiment of the poppet valve shown in FIG. 1.

FIGS. 3-1 and 3-2 are longitude sectional views of embodiments of a plug and a seat, respectively. FIGS. 3-3 and 3-4 are perspective views of embodiments of a plug and a seat, respectively.

FIGS. 4-1 and 4-2 are longitude sectional views of an embodiment of a magnetic core being translated within two solenoids.

FIGS. 5-1 and 5-2 are longitude sectional views of an embodiment of a magnetic core slidable over a guide rod attached to a plug.

FIGS. 6-1 and 6-2 are graphical representations of embodiments of valve control techniques.

### DETAILED DESCRIPTION

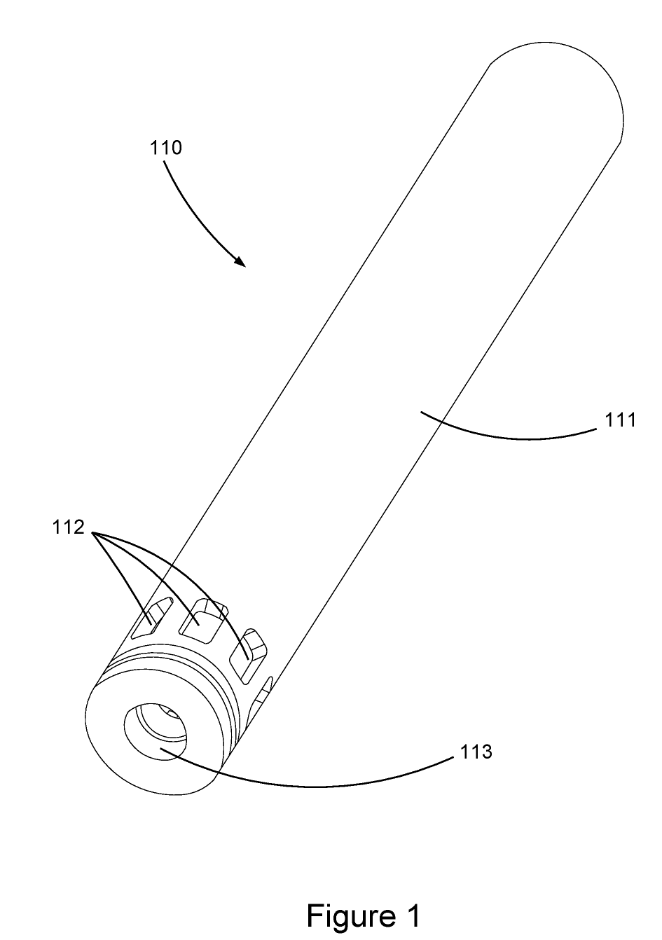

FIG. 1 shows an embodiment of a poppet valve 110 comprising a generally cylindrical body 111 comprising at least one inlet 112 and at least one outlet 113. In the embodiment shown, the at least one inlet 112 is disposed on a radial surface of the body 111 and the at least one outlet 113 is disposed on an axial surface. However, a variety of other configurations are possible.

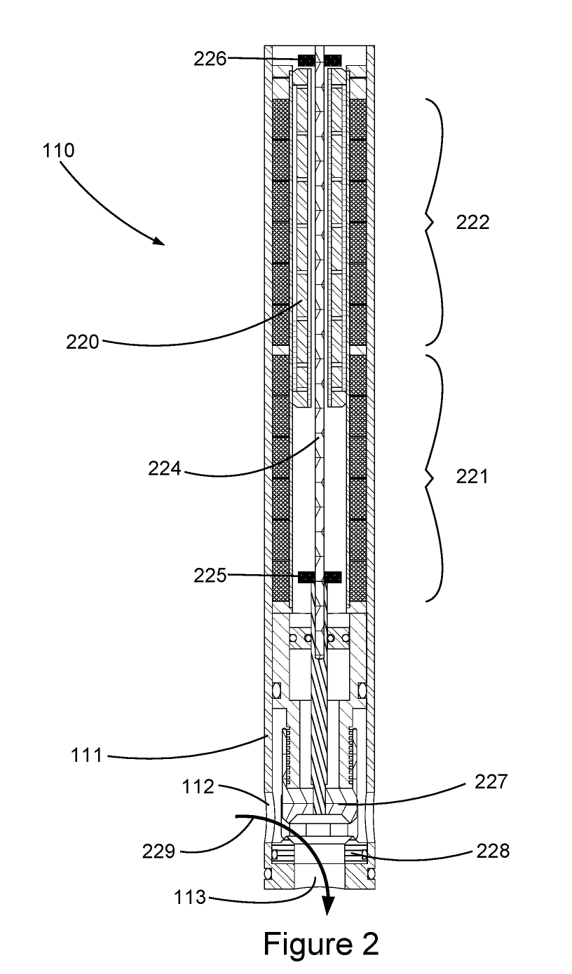

FIG. 2 shows that the poppet valve 110 of FIG. 1 comprises a magnetic core 220 disposed within at least one solenoid secured to an interior of the body 111. In this embodiment, the magnetic core 220 is disposed within a first solenoid 221 and a second solenoid 222 that are coaxial with and axially-spaced from one another. The magnetic core 220 may be freely translatable within the first solenoid 221 and second solenoid 222 along a common axis thereof.

The magnetic core 220 may comprise a generally toroidal form such that it may surround and slide over a guide rod 224 passing therethrough. In the embodiment shown, the guide rod 224 extends along a common axis of the first and second solenoids 221, 222 although other arrangements are possible. The guide rod 224 may comprise at least one anvil attached thereto. In this embodiment, the guide rod 224 comprises a first anvil 225 and a second anvil 226 spaced apart from one another along a length of the guide rod 224 with the magnetic core 220 translatable therebetween.

The guide rod 224 may also be attached to a plug 227 receivable by a seat 228. When received by the seat 228, the plug 227 may obstruct fluid 229 from flowing from the at least one inlet 112 through to the at least one outlet 113. To disengage the plug 227 from the seat 228, and therefore allow the fluid 229 to flow, at least one of the first or second solenoids 221, 222 may be excited by passing an electrical current therethrough. This excitement may form electromagnetic fields that may translate the magnetic core 220 and cause it to impact the second anvil 226. Such impact may travel through the guide rod 224 causing the plug 227 to move relative to the seat 228.

Those of ordinary skill in the art will recognize that, while the plug 227 of the embodiment shown is positioned on the same side of the seat 228 as the magnetic core 220, in other embodiments a plug may be positioned on an opposite side of a seat from a magnetic core with a guide rod passing through the seat and achieve similar results.

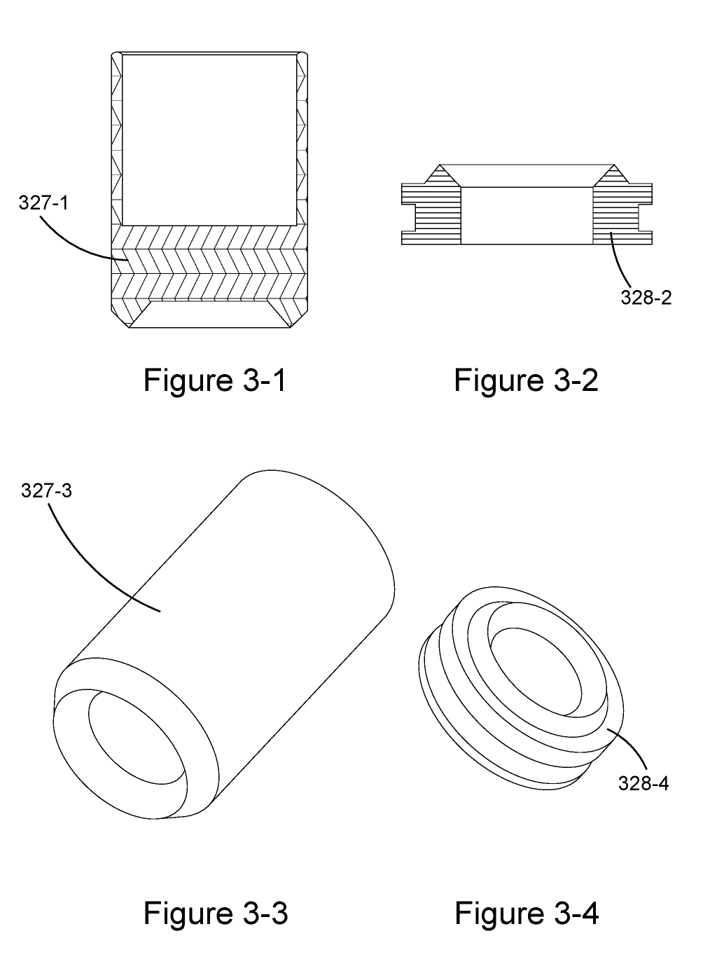

FIGS. 3-1 and 3-3 show embodiments of plugs 327-1, 327-3 and FIGS. 3-2 and 3-4 show embodiments of seats 328-2, 328-4. The plugs 327-1, 327-3 may be shaped so as to be receivable by the seats 328-2, 328-4. The plugs 327-1, 327-3 and seats 328-2, 328-4 of the embodiments shown are formed completely of a superhard material, such as polycrystalline diamond, and may be manufactured by sintering diamond particles together under high-pressure and high-temperature conditions and then machined to shape. Such superhard material may aid in preventing wear of valve surfaces where valves are used to control fluids comprising abrasive particles suspended therein. Those of ordinary skill in the art of will recognize that other embodiments formed completely or at least partially of superhard material may be manufactured from any of a variety of known methods.

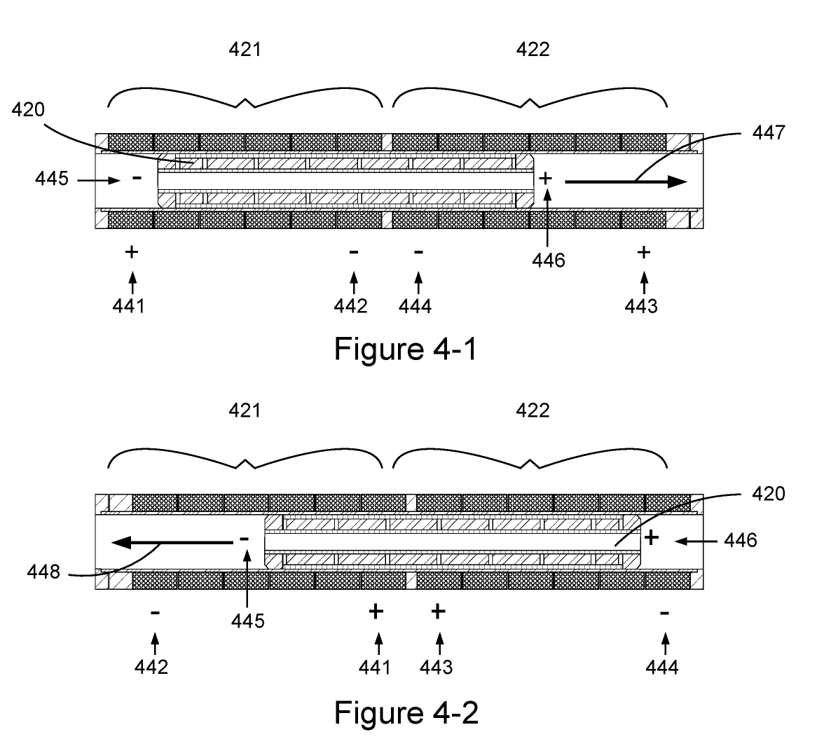

FIG. 4-1 shows an embodiment of a first solenoid 421 and a second solenoid 422 disposed adjacent one another on a common axis. A magnetic core 420 may be positioned within the first and second solenoids 421, 422 and free to translate along the axis. In the embodiment shown, the magnetic core 420 comprises a plurality of toroidally shaped magnets affixed together, however, other formations may perform similarly. In some embodiments, the first and second solenoids 421, 422 may be formed from a from a single wire wound in one direction to form the first solenoid 421 and then in an opposite direction to form the second solenoid 422. However, other configurations are also possible.

When excited by an electrical current passing therethrough, each of the first and second solenoids 421, 422 may act as an independent electromagnet. For example, if an electrical current is passed in one direction through first and second solenoids 421, 422, a positive charge 441 and a negative charge 442 may form on opposite ends of the first solenoid 421. Additionally, a separate positive charge 443 and negative charge 444 may form on opposite ends of the second solenoid 422. As can be seen, the positive and negative charges 441, 442 associated with the first solenoid 421 may be reverse from the positive and negative charges 443, 444 associated with the second solenoid 422 due to the reverse winding.

The magnetic core 420 may comprise a negative charge 445 permanently associated with one end thereof and a positive charge 446 permanently associated with an opposite end thereof. When the first and second solenoids 421, 422 are excited in the manner described above, the positive charge 446 and negative charge 445 of the magnetic core 420 may be repulsed by the oppositely aligned positive charge 441 and negative charge 442 of the first solenoid 421 and attracted by the similarly aligned positive charge 443 and negative charge 444 of the second solenoid 422. This combination of repulsion and attraction may urge the magnetic core 420 axially as shown by the arrow 447 in a controlled yet forceful manner.

If the direction the electrical current passes through the first and second solenoids 421, 422 is reversed the positive and negative charges will also reverse, as shown in FIG. 4-2. Specifically, FIG. 4-2 shows the magnetic core 420 having translated from its starting position and the positive charges 441, 443 and negative charges 442, 444 of first and second solenoids 421, 422, respectfully, having reversed. This reversal may urge the magnetic core 420 in a reverse direction than previously as shown by the arrow 448.

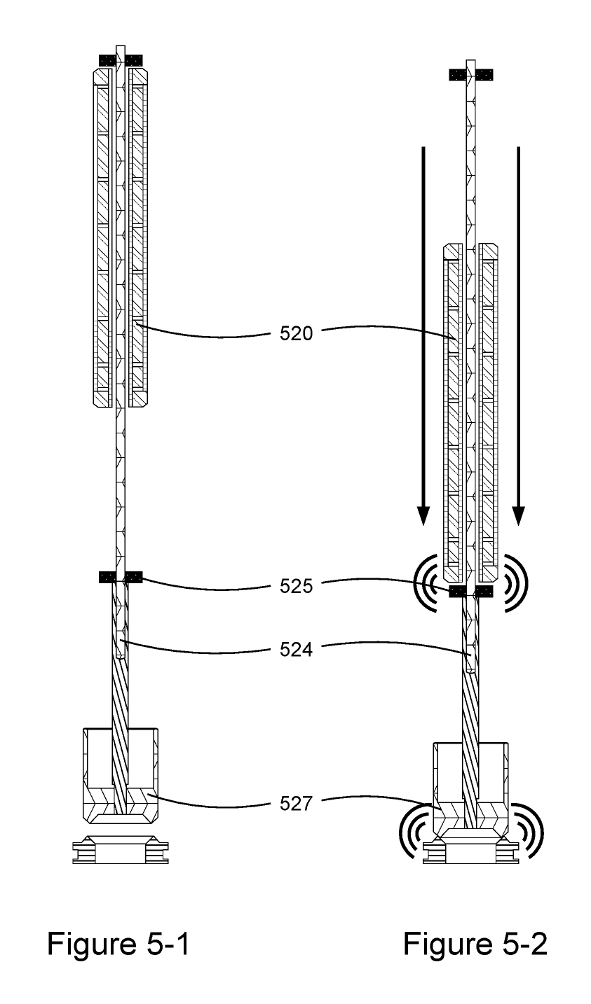

FIGS. 5-1 and 5-2 show an embodiment of a magnetic core 520 slidable over a guide rod 524. The guide rod 524 may be rigidly attached to a plug 527 such that they are translatable together. Kinetic energy may build up in the magnetic core 520 as it slides over the guide rod 524 and transfer to the plug 527 when the magnetic core 520 impacts at least one anvil 525 affixed to the guide rod 524. This kinetic energy may be transmitted into the plug 527 which may then collide into a seat 528 shaped to receive the plug 527, as shown in FIG. 5-2.

To protect the superhard material of the plug 527 and seat 528, which is commonly brittle, from fracture due to such collisions, translation of the magnetic core 520 may be controlled so as to provide a series of smaller impacts against the at least one anvil 525 rather than one large impact. This series of smaller impacts may cause the plug 527 to move incrementally toward the seat 528 and lessen the power dissipated in any one collision. It has also been found that such incremental movement may allow for smaller valve components leading to a smaller valve overall as well as an increased amount of control over the size of a gap between the plug 527 and the seat 528 through which fluid may flow allowing for throttling of the valve.

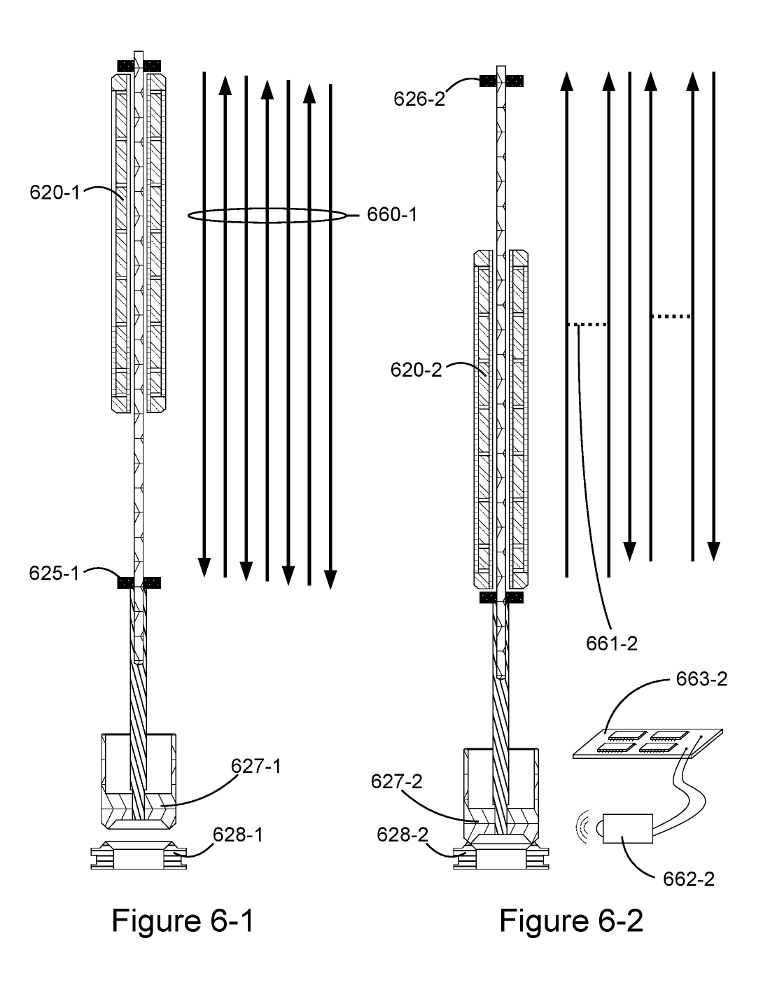

FIG. 6-1 shows an embodiment of a series of impacts 660-1 of a magnetic core 620-1 against an anvil 625-1 that may incrementally move a plug 627-1 into contact with a seat 628-1. If a plug 627-2 becomes difficult to disengage from a seat 628-2, as shown in an embodiment in FIG. 6-2, due to fluid deposits, high pressures or other reasons, then a series of impacts of a magnetic core 620-2 against a second anvil 626-2 may jar the plug 627-2 free. It has also been found that exciting solenoid coils in a way that causes the magnetic core 620-2 to impact the second anvil 626-2 for a greater duration of time 661-2 and then release for a lesser duration of time may also be beneficial to dislodging the plug 627-2. In any case, it may be valuable to measure a location of a plug relative to its respective seat with a position sensor 662-2, of any of a variety of types common in the art, as hammering is occurring and feed data gathered by the position sensor 662-2 into a control unit 663-2 for the solenoids.

Whereas certain embodiments have been described in particular relation to the drawings attached hereto, it should be understood that other and further modifications apart from those shown or suggested herein, may be made within the scope and spirit of the present disclosure.

1. A hammering valve, comprising:
a magnetic core translatable within at least one solenoid;
a plug comprising superhard material movable by impact of the magnetic core; and
a seat also comprising superhard material capable of receiving the plug.

2. The hammering valve of claim 1, wherein the superhard material of both the plug and the seat comprises polycrystalline diamond.

3. The hammering valve of claim 2, wherein both the plug and the seat are formed completely of polycrystalline diamond.

4. The hammering valve of claim 1, wherein the at least one solenoid comprises two axially-spaced coaxial solenoids.

5. The hammering valve of claim 4, wherein the two solenoids are formed from a single wire oppositely wound for each solenoid.

6. The hammering valve of claim 1, further comprising at least one anvil attached to the plug and impactable by translation of the magnetic core.

7. The hammering valve of claim 6, wherein the at least one anvil comprises two axially-spaced coaxial anvils.

8. The hammering valve of claim 1, wherein the magnetic core is translatable along a guide rod passing through the at least one solenoid.

9. The hammering valve of claim 8, wherein the guide rod is attached to the plug.

10. The hammering valve of claim 8, further comprising at least one anvil attached to the guide rod and impactable by translation of the magnetic core.

11. The hammering valve of claim 10, further comprising two anvils, both attached to the guide rod.

12. The hammering valve of claim 8, wherein the magnetic core comprises a toroidal shape surrounding and coaxial with the guide rod.

13. A method for opening a valve, comprising:
translating a magnetic core by excitation of a solenoid; and
moving a plug, comprising superhard material, relative to a seat, also comprising superhard material, by impact of the magnetic core.

14. The method of claim 13, wherein moving the plug relative to the seat comprises moving the plug incrementally.

15. The method of claim 14, wherein moving the plug incrementally is performed by a plurality of impacts of the magnetic core.

16. The method of claim 13, wherein moving the plug relative to the seat comprises moving the plug in opposing directions by impacts of the magnetic core in opposing directions.

17. The method of claim 16, wherein the impacts of the magnetic core in opposing directions is performed by reversing current within the solenoid.

18. The method of claim 17, wherein reversing current within the solenoid comprises:
passing current through the solenoid in a first direction for a first duration; and
passing current through the solenoid in a second direction, opposite to the first direction, for a second duration; wherein
the first duration is greater than the second duration.

19. The method of claim 13, further comprising measuring a location of the plug relative to the seat with a position sensor.

20. The method of claim 19, further comprising using data from the position sensor to control the solenoid.
